(19) United States
(12) Patent Application Publication
(10) Pub. No.: US 2012/0088009 A1
(43) Pub. Date: Apr. 12, 2012

(54) SALEABLE COGNITIVE PERFORMANCE SNACK FOOD ITEMS AND METHODS OF PREPARING, PACKAGING AND USING SAME

(76) Inventor: Keith MULLIN, La Jolla, CA (US)

(21) Appl. No.: 13/271,753

(22) Filed: Oct. 12, 2011

Related U.S. Application Data
(63) Continuation-in-part of application No. 12/269,674, filed on Nov. 12, 2008.
(60) Provisional application No. 61/003,007, filed on Nov. 13, 2007.
(60) Provisional application No. 61/404,917, filed on Oct. 12, 2010.

(51) Int. Cl. A23L 1/30; B65B 1/00; A23P 1/04

(52) U.S. Cl. 426/2; 426/392; 426/96

(57) ABSTRACT

A method of providing a cognitive performance snack food to a user includes producing a multitude of snack food pieces, placing the multitude of snack food pieces in snack packaging adapted to be self-standing when placed on a general horizontal surface, and providing a saleable performance snack food item to consumers for use during computer or video game activity. Some snack food pieces include a snack food base, a mixture of cognitive performance additives; and in some cases an outer shell. The snack pieces and snack packaging together define the saleable performance snack food item, which can be consumed with one hand and while operating computer or video gaming equipment.

### CROSS-REFERENCE TO RELATED APPLICATIONS

The present application is a U.S. continuation-in-part patent application of, and claims priority under 35 U.S.C. §120 to, U.S. patent application Ser. No. 12/269,674 to Mullin, filed Nov. 12, 2008 entitled “SALEABLE COGNITIVE PERFORMANCE SNACK FOOD ITEMS AND METHODS OF PREPARING, PACKAGING AND USING SAME” and published as U.S. Patent Application Publication No. 2009/0123610 A1 on May 14, 2009, which patent application and publication are incorporated by reference herein, and which patent application is a U.S. nonprovisional patent application of U.S. Provisional Patent Application No. 61/003,007, filed Nov. 13, 2007, which is also incorporated by reference herein. The present application is also a U.S. nonprovisional patent application of, and claims priority under 35 U.S.C. §119(e) to, U.S. provisional patent application Ser. No. 61/404,917, filed Oct. 12, 2010, which '917 application is incorporated by referenced herein in its entirety.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

1. Field of the Present Invention

The present invention relates generally to novel snack food items, and, in particular, to methods of preparing, packaging in flexible packaging and using a saleable cognitive performance snack food item.

2. Background

In general, snack foods consist of a high proportion of unhealthy additives and are low in ingredients which support cognitive functions. An increasing number of the population interacts with media or programs displayed on projection, cell phone, computer or TV screens, performing activities such as, email, computer games, video games, and other such hyper-active and cerebral intense interactions while substituting snack foods for their regular meals. Therefore, it is a nutritional and functional necessity to introduce a palatable snack food which supports cognitive actions and can be consumed without interfering with media or computer control devices such as a keyboard, joystick or computer/video game controller or decreasing the performance of such said devices and activities.

It can be appreciated that snack foods have been in use for years. Typically, snack foods are potato chips, candy bars, corn chips, pizza, popcorn, crackers, cookies, donuts, biscuits, nuts, fruit mixes, chicken wings, granola bars, power bars, with the majority using packaging of boxes or bags or in containers with screw-off or snap-on lids. The majority of these snack foods are consumed by the user directly touching the food with their hands. None of these snack foods are manufactured with a cognitive premix installed.

For computer users and gamers, a significant drawback of conventional snack foods are they provide no or little support to cognitive function. Another problem with conventional snack foods are that they are not provided in a package or method of use which allows for easy one-hand consumption and when handled the snack food renders the hands greasy or with food residue or oils/grease. Another problem with existing products is that when partly eaten, and temporarily placed down, they contact with a surface, leaving said surface messy with food residue. Another problem with existing products is that when eaten, food participles and crumbs will break away and fall onto surrounding surfaces and become lodged in computer keyboards. Another problem with conventional snack food is that they are not provided in shapes which can be easily poured.

While past and existing snack foods may be suitable for the particular purpose to which they address, they do not generally support cognitive function. An increasing number of the population eats while watching TV, working on the computer or playing video games. Therefore, from a nutritional perspective, it would be very useful to introduce a palatable food snack which supports mental performance and can be consumed while participating in said activities.

In these respects, the method of preparing, packaging in flexible packaging and using a cognitive supporting food according to the present invention substantially departs from the conventional methods, concepts, formulas and designs of the prior art, and in so doing provides a method, food and apparatus primarily developed for the purpose of supporting mental performance and provides such food in a device where the user can consume said snack by the operation of packaging occurring with one hand.

### SUMMARY OF THE PRESENT INVENTION

The present invention includes many aspects and features. In particular, in view of the foregoing disadvantages inherent in the known types of snack food and packaging now present in the prior art, the present invention provides a new method of preparing a cognitive supporting food and packaging device wherein the same can be consumed and utilized while interacting with abovementioned screen media and related electronic or program controllers as well as other hyper-active and cerebral intense activities. However, while many aspects and features relate to, and are described in, the context of saleable cognitive performance snack food items, the present invention is not limited to use only in saleable cognitive performance snack food items, as will become apparent from the following summaries and detailed descriptions of aspects, features, and one or more embodiments of the present invention.

Accordingly, one aspect of the present invention relates to a method of providing a cognitive performance snack food to a user, including: producing a multitude of individual snack food pieces, each snack food piece including a snack food base, a mixture of cognitive performance additives and outer shell; installing the mixture of cognitive performance additives in or on the food base and then encapsulating all with an eatable outer shell; and placing a multitude of snack food pieces in a snack packaging. The manufactured snack pieces and snack packaging, together defining a saleable performance snack food item, are provided to consumers for use during computer or video game activity.

In a feature of this aspect, placing the multitude of snack food pieces in a snack packaging includes placing the multitude of snack food pieces in a flexible snack packaging adapted to be placed in a standing, upright position when not in use.

In another feature of this aspect, another step, performed by a consumer, includes consuming at least a portion of the multitude of snack food pieces while participating in computer work or video game activity.

In another feature of this aspect, the consuming step is carried out while manipulating a computer or video game controller or keyboard device.

In another feature of this aspect, the method further includes a step, performed by a consumer while participating in computer or video game activity, after opening the flexible snack packaging and consuming a portion of the snack, the consumer may place the packaging on a generally horizontal surface where the flexible packaging will stand upright.

In another feature of this aspect, the providing step includes promoting sale of the saleable performance snack food item to consumers for use during computer or video game activity. In a further feature, promoting sale of the saleable performance snack food item to consumers for use during computer or video game activity includes offering the saleable performance snack food item for sale in association with offering computer or video games for sale or rental.

Another aspect of the present invention is a cognitive performance snack food, adapted to be consumed while engaging in computer or video game activity and to provide cognitive performance enhancement thereby, including: a plurality of granular snack food pieces, each piece including a snack food base piece, a mixture of cognitive performance additives and an outer shell. Each snack food base piece begins as a non-solid food mixture, and wherein the cognitive performance mixture is add-mixed with the food mixture to obtain a homogeneous mixture of food material. The snack food base piece then may be made to a solid or semi-solid state by being cooked, dried, frozen, refrigerated or let them harden at room temperature thus rendering a solid snack piece. The solid snack piece may then be encapsulated by an outer eatable shell. The solid snack pieces are granular and are adapted to be pourable from a flexible dispensing container. In a feature of this aspect, a plurality of solid snack food pieces are the first plurality of snack food pieces, the cognitive performance snack food further includes a second plurality of snack food pieces who do not contain the mixture of cognitive performance additives installed thereto, and the first and second pluralities of snack food pieces are adapted to be pourable from the dispensing container. In a feature of this aspect, a plurality of solid snack food pieces are the first plurality of snack food pieces, the cognitive performance snack food are adapted to be pourable from the dispensing container without any additional snack food pieces.

Yet another aspect of the present invention is a saleable performance snack food item, adapted to be consumed while engaging in computer or video game activity and to provide cognitive performance enhancement thereby, including: a snack flexible packaging adapted to stand freely on its own without support; and a cognitive performance snack food, contained in the snack flexible packaging, arranged in snack food pieces, the snack food including a snack food base, a mixture of cognitive performance additives and on outer shell. In a feature of this aspect, the solid snack food pieces are granular and adapted to be pourable from the flexible snack packaging.

In another feature of this aspect, the snack food base is prepared as a food mixture, and wherein the cognitive performance mixture is combined with the food mixture to obtain a homogeneous mixture of food material. In further features, each piece of the cognitive performance snack food is cooked from the homogeneous mixture; and each piece of the cognitive performance snack food is shaped from the homogeneous mixture prior to being made solid or semi-solid by being cooked, dried, frozen, refrigerated or let them harden at room temperature.

In another further feature of this aspect, each piece of the cognitive performance snack food is a snack food base piece, with a solid structure, having surfaces to which the mixture of cognitive performance additives is applied then all are encapsulated with an outer shell. In further features, each snack food base piece is a naturally occurring food; or each snack food base piece is a previously prepared snack food piece.

In another further feature of this aspect, each piece of the cognitive performance snack food is a snack food base piece and an outer shell. The cognitive performance additives are contained in the outer shell and applied to the snack food base piece during encapsulation. In further features, each snack food base piece is a naturally occurring food; or each snack food base piece is a previously prepared snack food piece.

In a still further feature of this aspect, the flexible snack packaging includes a resealing opening system.

The general purpose of the present method and invention, which will be described subsequently in greater detail, is to provide a new method of preparing, packaging in flexible packaging and using a cognitive supporting snack food that has many of the advantages of the snack food mentioned heretofore and many novel features that result in a new method of preparing, packaging in flexible packaging and using a cognitive supporting snack food which is not anticipated, rendered obvious, suggested, or even implied by any of the prior art snack food, either alone or in any combination thereof.

To attain this, the present invention generally comprises a cognitive premix, the food base, the performance snack and the flexible snack packaging. The cognitive premix is a mixture of food additives which support cognitive function. The food base is a food product. The performance snack is the resultant substance or food created when the cognitive premix and food base are combined together which then may be encapsulated by an outer shell. The flexible snack packaging is the one hand operating dispenser for the present food invention.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the method and invention in detail, it is to be understood that the method and invention is not limited in its application to the details of method, construction or design and to the arrangements of the components set forth in the following description or illustrated in the drawings. The method and invention is capable of other embodiments and of being practiced and carried out in various ways. Also, it is to be understood that the phraseology and terminology employed herein are for the purpose of the description and should not be regarded as limiting.

An object of the present invention is to provide a method of preparing, packaging in flexible packaging and using a cognitive supporting snack food that will overcome the shortcomings of the prior art devices.

Another object of the present invention is to provide a method of preparing, packaging in flexible packaging and using a snack food which supports neurotransmission and cognitive function.

Another object of the present invention is to provide a method of preparing, packaging in flexible packaging and using a cognitive supporting snack food which can be consumed with one hand while interacting with video games controllers while providing a cognitive supporting food snack which supports mental performance while participating in said computer activities.

Another object is to provide a method of preparing, packaging in flexible packaging and using a cognitive supporting snack food that has a composition enriched with cognitive supporting additives which may be used as additives in snack foods. A method of preparing a cognitive supporting snack food comprises admixing of a cognitive premix and food matter to obtain a homogeneous mass. This mixture can then be formed into desired shapes, cooking or cooling to render said material in a solid form, thus making the performance snack.

Another object is to provide a method of preparing and packaging a cognitive supporting food that is provided in flexible packaging which enables for one hand consumption of a snack food.

Another object is to provide a method of preparing and packaging a cognitive supporting food that does not leave food residue such as grease or particles on the hands when consuming.

Another object is to provide a method of preparing and packaging a cognitive supporting food that is not prone to fall out of the mouth of pieces or crumbs when eating.

Another object is to provide a method of preparing and packaging a cognitive supporting food that is packaged in flexible packaging that stands vertically on its own, when placed on a generally horizontal surface.

Another object is to provide a method of preparing and packaging a cognitive supporting food that supports mental acuity, reaction times, concentration and supports the signal response in the nervous system.

Other objects and advantages of the present method and invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a partially cutaway side view of a saleable performance snack food item in accordance with one or more preferred embodiment of the present invention;

FIG. 2 is a block diagram illustrating basic components of the performance snack food item of FIG. 1;

FIG. 3 is a cross section of a performance snack piece of FIG. 1;

FIG. 4 is a label listing of potential cognitive performance enhancers;

FIG. 5 is a top view of the saleable food item of FIG. 1, shown in a closed state;

FIG. 6 is a top view of the saleable food item of FIG. 1, shown in an open state;

FIG. 7 is a side view of the saleable food item of FIG. 1, shown with the opening assembly removed from the packaging;

FIG. 8 is a bottom perspective view of the saleable food item of FIG. 1;

FIG. 9 is a side perspective view of an alternate snack packaging, for a performance snack, in accordance with one or more preferred embodiments of the present invention;

FIGS. 10-13 are flowcharts illustrating methods of preparing, packaging and using a saleable cognitive performance snack food item; and

FIG. 14 is a perspective view of the snack packaging of FIG. 1, shown with the flexible packaging self-standing on a generally horizontal surface and being operated by a hand.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, the preferred embodiments of the present invention are next described. The following description of one or more preferred embodiment(s) is merely exemplary in nature and is in no way intended to limit the invention, its application, or uses.

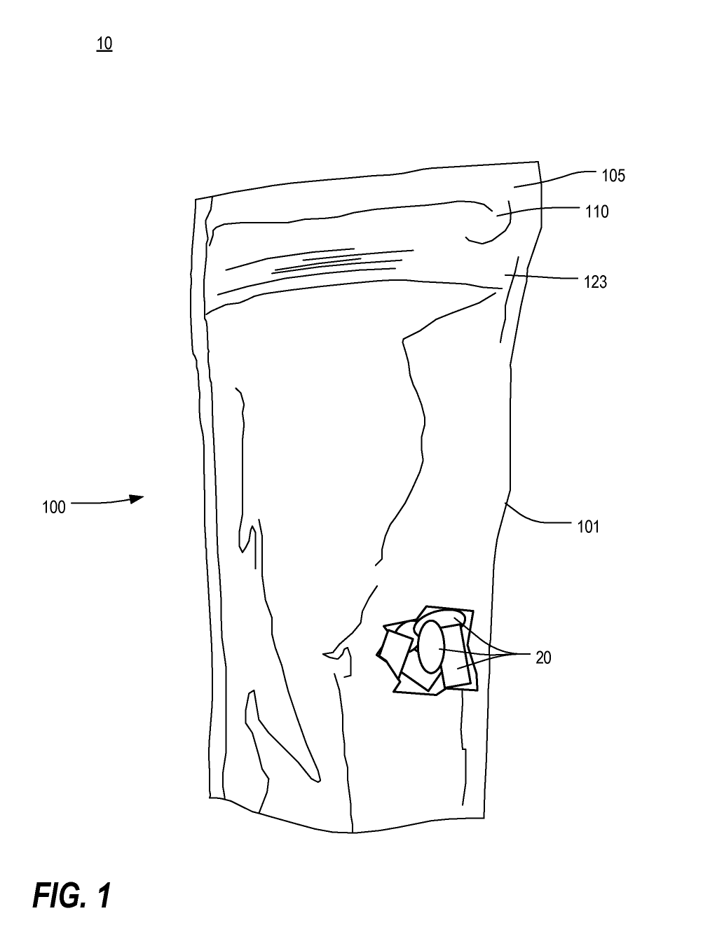

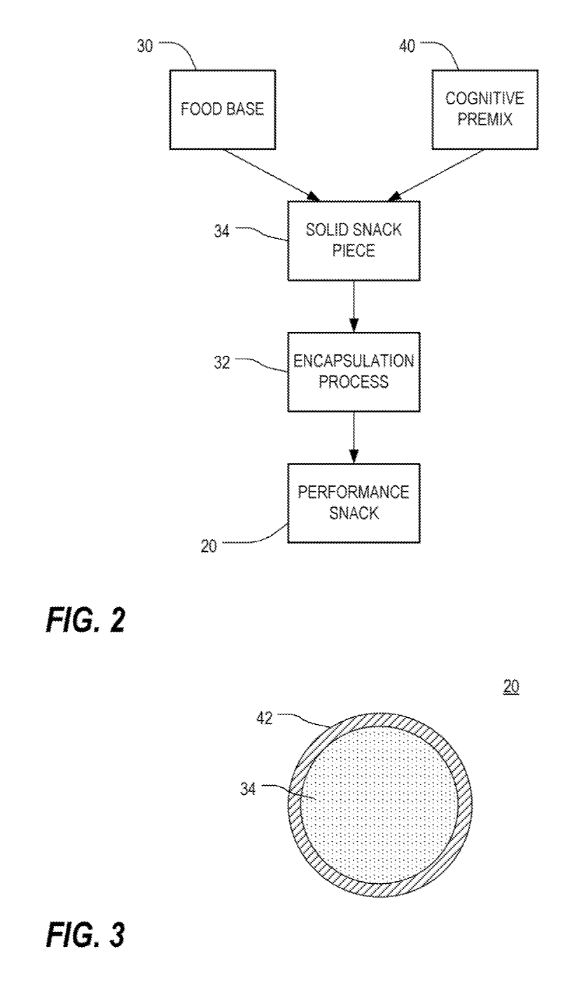

FIG. 1 is a partially cutaway side view of a saleable performance snack food item 10 in accordance with one or more preferred embodiment of the present invention. The saleable food item 10 includes a cognitive performance snack food 20, which is the resultant substance when a food base 30 and a cognitive premix 40 are combined and then encapsulated 32 with outer shell 42 via process shown in FIG. 2, and placed in flexible snack packaging 100, which is the container and dispenser for the performance snack. Each of these will be described in greater detail herein below.

In another embodiment, cognitive performance snack food 20 is placed in a rigid snack packaging.

FIG. 2 is a block diagram illustrating basic components of the performance snack of FIG. 1. The performance snack 20, which in at least some embodiments includes a multitude of individual snack food pieces, is produced from an encapsulation process 32 of a solid snack piece 34 which is comprised of food base 30 and a cognitive premix 40. The food or snack base 30 is a food product or food mixture. In at least some embodiments, the food base 30 is a non-solid material and is used to obtain a homogeneous mass of non-solid material when mixed with the cognitive premix 40. The homogeneous non-solid material is then made to a semi-solid or solid form by being cooked, frozen, refrigerated or set to room temperature to render solid snack piece 34. The solid snack piece 34 may then be broken or separated into smaller solid snack piece(s) 34, if desired. A food material outer shell 42 is then applied to the solid snack piece(s) 34 via the encapsulation process 32.

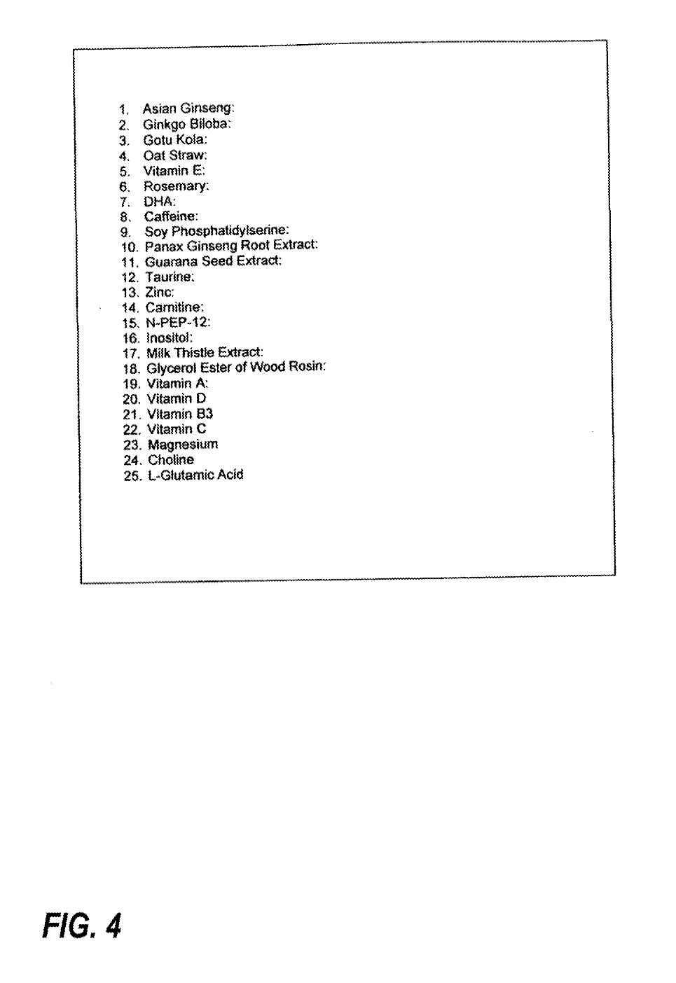

The cognitive premix 40 is a mixture of additives which support cognitive function. The cognitive premix 40 may be a single, mixture or a combination of food additives which have been shown to support cognitive functions. Representative food additives for the cognitive premix 40 or a combination of food additives are shown as potential additives in FIG. 4. In a preferred embodiment, the selected additives include Vitamin A, Vitamin E, Vitamin B3, Vitamin C, Magnesium, Choline, and L-Glutamic Acid. Even more preferably, Vitamin A is in the form of betacarotene, Vitamin E is in the form of Acetate, Vitamin B3 is in the form of Niacinamide, Vitamin C is in the form of Ascorbic Acid, and Choline is in the form of Choline Bitartrate.

The cognitive premix 40 is selected from any food materials or additives which have been shown to support cognitive performance. As a representative mixture of cognitive premix 40, the cognitive premix 40 may be made from some or all of the group shown in FIG. 4 in various percentages by weight. The material parts or elements for the cognitive premix 40 can be extracted from any source material containing the said individual ingredients. The cognitive premix 40 is comprised of any or all of the mentioned ingredients as well as those not shown in FIG. 4, which have been shown to support cognitive performance. The cognitive premix 40 can be manufactured in a powder, liquid, liquid slurry or gel which is suitable for inclusion, mixing, coating or topical surface application as an additive into a food item or food base. The cognitive premix 40 can be add-blended or mixed with a liquid if needed in a manner to form the desired material consistency for add-mixing or surface application.

The performance snack 20 is the resultant substance when the food base 30 and the cognitive premix 40 are combined together via process of forming a solid snack piece 34 and encapsulation process 32 as shown in FIG. 2. The performance snack 20 may be rendered in a semi-solid material such as a gummy or soft candy. The performance snack 20 may also be rendered by surface application of the cognitive premix 40 which is contained in the outer shell 42 which is then coated on solid snack piece 34. The performance snack 20 can be extruded, stamped or formed to create various shapes. Thickening, stabilizing, emulsifying agents, liquids, oils, fats, or gums adjusters may be added to the performance snack 20 to render the preferred characteristics of the end product stated herein. Flavoring or coloring agents may also be added to the performance snack 20 to provide a pleasing color, mouth feel and palatability.

In at least some embodiments, the performance snack 20 is produced in one or more shapes designed to represent, suggest or coordinate with forms typically found or associated with particular activities in which target consumers are likely to be participating while consuming the snack 20 such as forms typically found in computer or video game imagery.

As illustrated in FIG. 3 which is a cross section of the performance snack piece 20, the performance snack piece 20 is comprised of solid snack piece 34 and encapsulated by outer shell 42. The performance snack 20 can be formed or extruded into any shape. The outer shell 42 can be comprised of a single or multiple layers of food material suitable for the purposes of encapsulation process 32. The outer shell 42 can also contain cognitive premix 40 which is then applied to solid snack piece 34 via encapsulation process 32. The outer shell 42 can be of various seasonings, colorings or flavoring agents. The performance snack 20 can also be formed by topically applying or surface coating the cognitive premix 40 to such solid foods as fruits (for example, raisins), nuts (for example, peanuts or almonds) or grains or other manufactured food pieces (for example, cheese curls, sesame sticks, cookies, chips, etc.) then outer shell 42 can be installed via the encapsulation process 32.

The flexible snack packaging 100 is the flexible container and dispenser for the performance snack 20. The flexible snack packaging 100 includes a snack container 101 and a opening assembly 110, for the present snack food invention, which provides storage of the snack composition in a sealed, oxygen impermeable container. The snack packaging 100 can be made of any shape or material suitable for the intent of use stated herein.

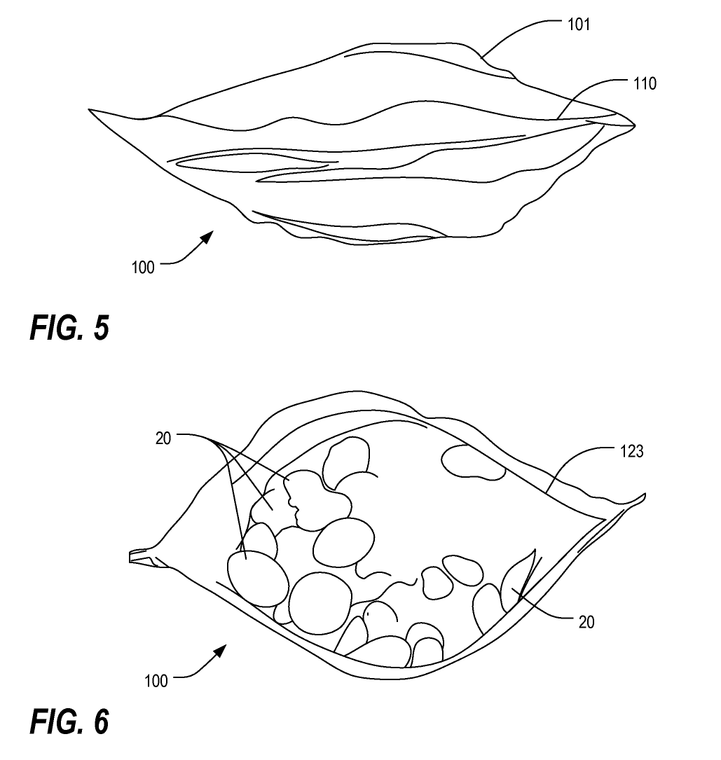

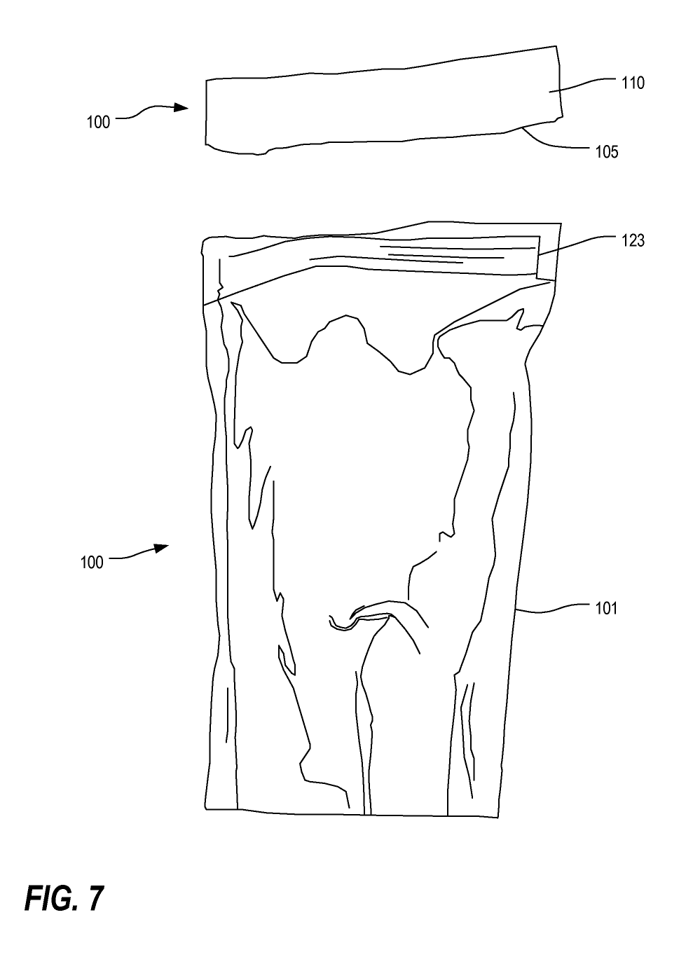

In at least one embodiment, the opening assembly 110 includes a heat sealed closure system (not shown) and a re-sealable system 123. FIGS. 5 and 6 are top views of the saleable food item 10 of FIG. 1, shown with the opening assembly 110 in a closed state and an open state, respectively. Each opening assembly 110 includes a rip-away groove 105 and a re-sealable system 123. Re-sealable system 123 is provided to reseal the flexible packaging when not in use. The rip-away groove aids in tearing a portion of the top of the packaging off, as shown in FIG. 7, thus exposing the re-sealable system 123 for use.

Although not shown, the flexible snack packaging 100 may be provided without the re-sealable system 123.

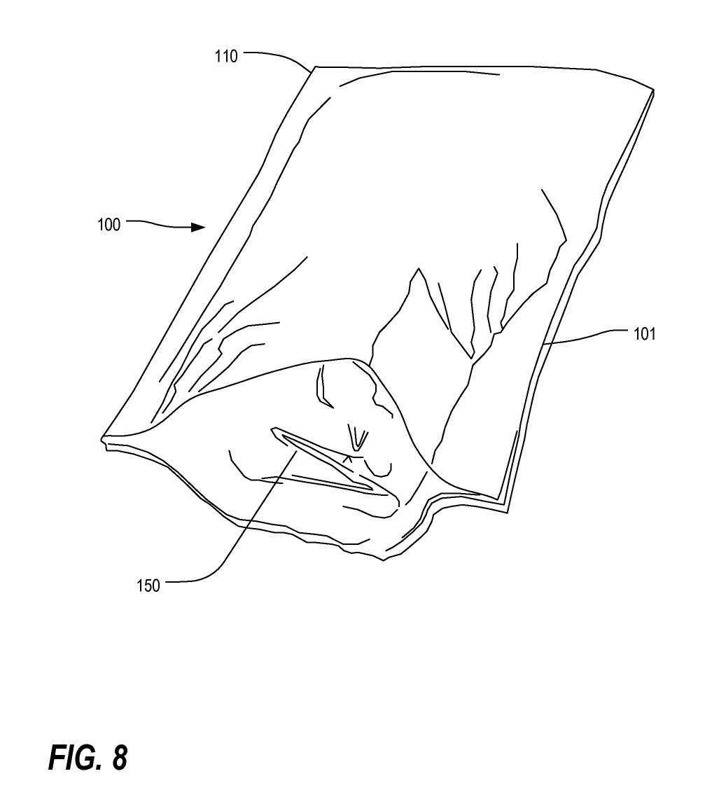

FIG. 8 is a bottom view of the present invention, which shows the bottom gusset 150 used for the present invention to self-stand on a generally horizontal surface. The bottom gusset 150 is formed with flexible material which renders a foundation for the vertical structure of the flexible snack packaging 100 when filled with performance snack 20. Via weight of the performance snack 20, bottom gusset spreads out, thus creating the footprint or foundation for flexible snack packaging 100.

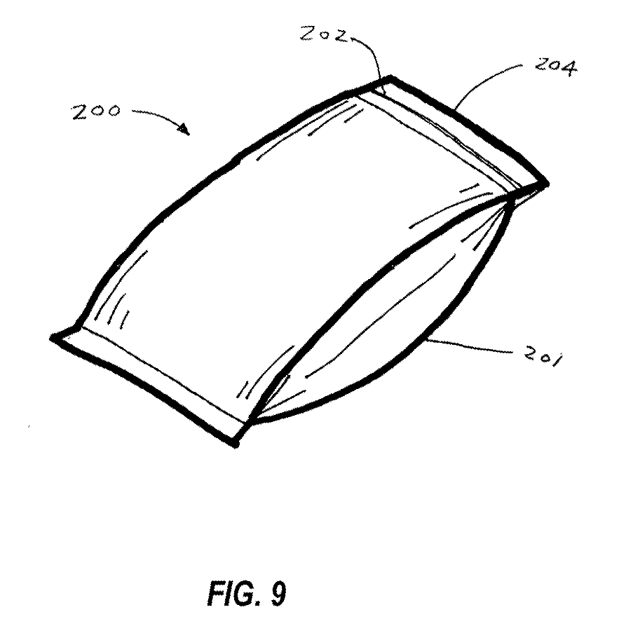

FIG. 9 is a front elevation view of an alternate snack packaging 200, for a performance snack 20, in accordance with an embodiment of the present invention with no bottom gusset. The snack packaging 200 is the container and dispenser for the performance snack 20. The snack packaging 200 includes a flexible snack container 201 and an opening assembly 204, for the present snack food invention, which provides storage of the snack composition in a sealed, oxygen impermeable container. The snack packaging 200 can be made of any shape or material suitable for the intent of use stated herein.

In view of the foregoing, it will be appreciated that in various embodiments, the flexible snack packaging 100,200 can be designed with any method or means in which the consumer can hold and consume the present invention snack 20 with one hand and can pour said performance snack into his or her open mouth together with placing the flexible snack packaging on a generally horizontal surface to self-stand when not in use.

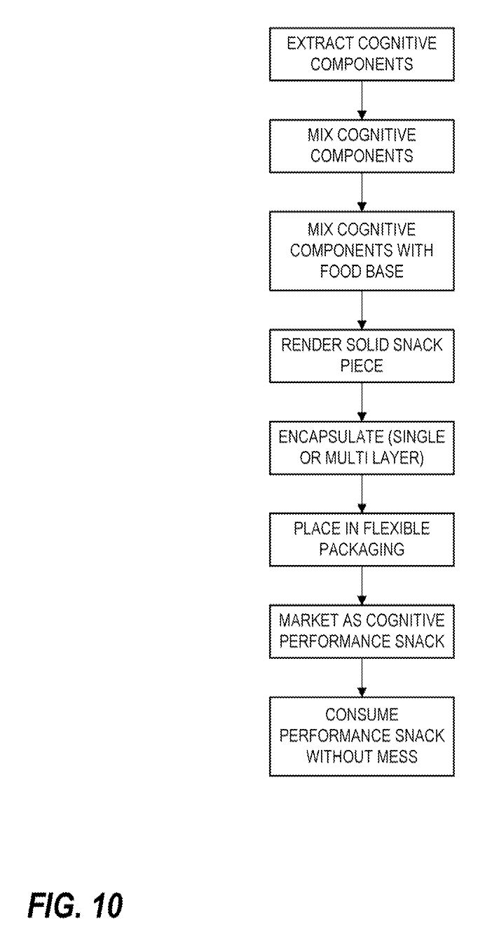

FIGS. 10-13 are flowcharts illustrating methods of preparing, packaging in packaging and using a saleable cognitive performance snack food item 10, which comprises a performance snack 20, produced from a food base 30, a cognitive premix 40, outer shell 42, and a flexible snack packaging 100. In each illustrated method, the cognitive premix 40, with various representative materials listed in FIG. 4, are extracted from the various sources in which they are found. Water or other suitable liquid can be used to produce a gel or slurry. Thickening, stabilizing, emulsifying agents or gums may also be added to produce the desired consistency of a gel. The cognitive premix 40 is then added to the food base 30 by admixing or via encapsulation process 32 when premix 40 is contained in outer shell 42.

In the method of FIG. 10, the extracts are combined from the selected group in various percentages by weight with a food mix to obtain a homogeneous mass of material, thus rendering a cognitive premix 40 which then can be shaped or cooked or added to another food or mix. The performance snack material then can be made directly into various shapes. The snack food shape or shapes formed with the performance snack can be of any form. A saleable performance snack food item may include a multitude of individual snack food pieces, each of which is formed from the mixture of the snack food base and the cognitive premix 40.

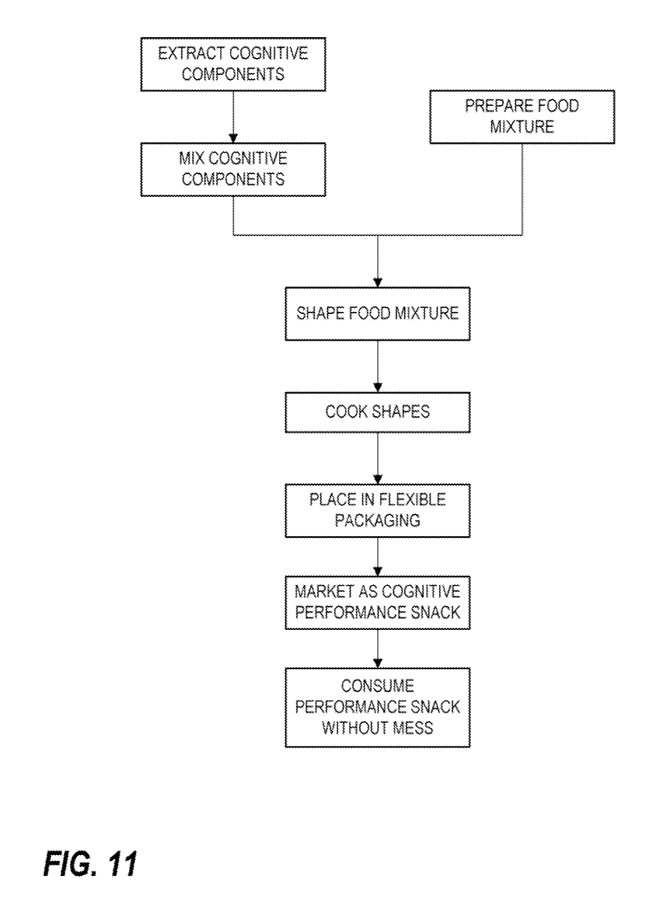

In the method of FIG. 11, the food mix is prepared separately. The resulting mix may be baked or otherwise cooked in various shapes, and the cognitive premix 40 is then surface applied to the snack shapes. A saleable performance snack food item may include a multitude of individual snack food base pieces, each of which is formed from the snack food base mixture, on some or all of the surfaces of which the cognitive premix 40 has been installed.

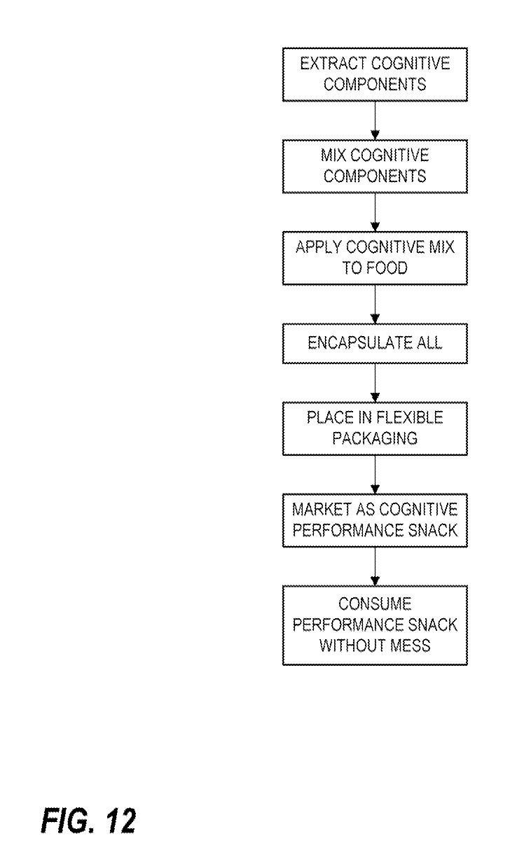

In the method of FIG. 12, the cognitive premix 40 is surface applied to another non-mixed or previously-mixed food, such as a granola bar, trail mix, chips, crackers, sesame sticks or other typical snack food to conform to their shape, taste or palatability. The food may be or include one or more naturally occurring foods, such as fruits, nuts, or the like, or may be or include independently prepared foods, or may include both, which are then encapsulated by an outer shell 42. A saleable performance snack food item may include a multitude of comprising another non-mixed or previously-mixed food, on the surfaces of which the cognitive premix 40 has been applied.

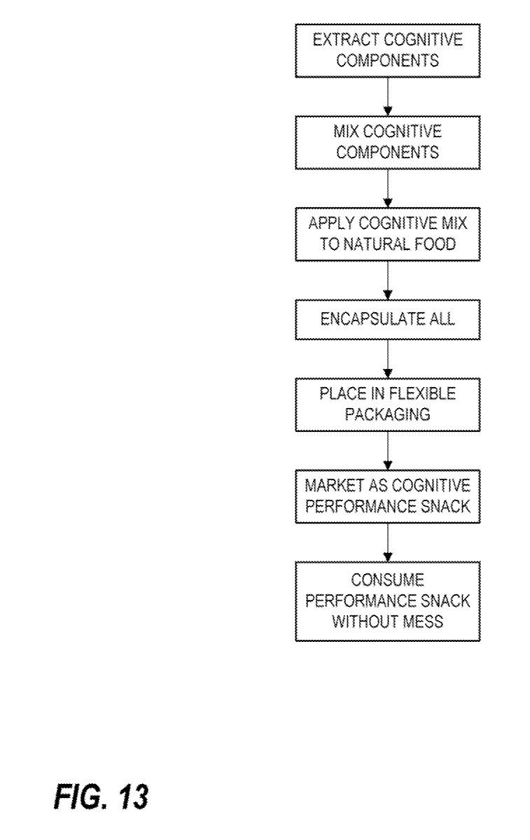

In the method of FIG. 13, pieces of a natural food, such as a fruit or nut, are prepared separately. The cognitive premix 40 is then surface applied to the fruit or nut piece. A saleable performance snack food item may include a multitude of individual snack food base pieces, each of which is formed from a fruit or nut piece, on the surfaces of which the cognitive premix 40 has been applied.

Preferably, the snack food pieces are granular in nature and are produced in a size and shape such that they are easily poured from one or more of the containers or pouches described herein. Performance snack 20 can be combined with other food items or pieces to create a snack mix. The combined resultant snack mix may then be packaged in snack packaging 100,200.

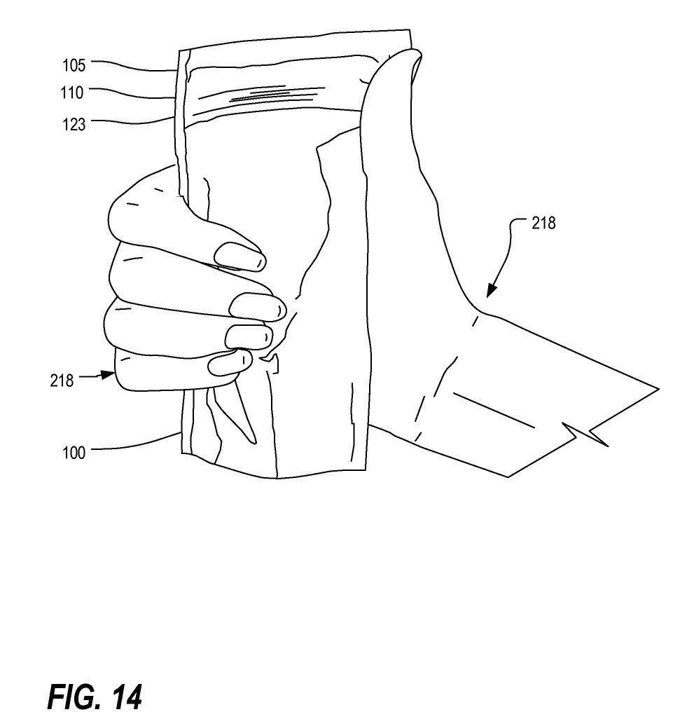

Although in at least one embodiment the final snack food product can be served directly, the resultant snack food is, in most embodiments, then placed in snack packaging 100 for sale and consumption at a later date. As particularly highlighted in FIG. 14 the snack packaging 100 can have a means to open, consume and close snack packaging 100. This method of operation is ideal with consuming the present invention snack while playing computer or video games. In particular, a consumer may continue to manipulate a game control device, such as a keyboard, mouse, joystick, specialized game control device, or the like, while consuming at least a portion of the snack food pieces by pouring snack piece directly into mouth, thus not touching snack food pieces and keep hands clean.

The final snack food rendered by the making is a food item which supports cognitive function for the consumer. Such cognitive support provided by the present method and invention may be particularly advantageous when participating in tasks or activities where speed of information acquisition, processing and reaction is critical, such as in jet fighter pilot, astronaut or computer gaming activities.

Furthermore, because of the advantages provided by a snack that may be easily consumed by a person carrying out other activities, such as computer or video gaming activities, and the advantages of supporting cognitive function during such activities, one or more methods of the present invention may further include specific marketing or distribution activities aimed at sales to consumers who are likely to participate in such activities.

As to a further discussion of the manner of usage and operation of the present method and invention, the same should be apparent from the above description. Accordingly, no further discussion relating to the manner of method, usage and operation will be provided.

With respect to the above description then, it is to be realized that the optimum dimensional relationships for the parts of the invention, to include variations in size, mass measurements, materials, shape, form, function and manner of operation, assembly and use, are deemed readily apparent and obvious to one skilled in the art, and all equivalent relationships to those illustrated in the drawings and described in the specification are intended to be encompassed by the present invention. As will be readily apparent to those skilled in the art, a host of food coloring materials, flavoring and flavor-enhancing agents may be utilized, in various amounts and combinations, to provide snack foods having particular visual and taste characteristics. Likewise, the size and shape of individual pieces of the snack food is not a limiting factor, so long as size and shape meet with consumer acceptance. Other modifications and variations, falling within the true broad spirit and scope of the invention, will be obvious to those skilled in the art.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is claimed is:

1. A method of providing a cognitive performance snack food to a user, comprising:
producing a multitude of individual snack food pieces, each snack food piece including a snack food base, a mixture of cognitive performance additives, and an edible outer shell;
placing the multitude of snack food pieces in a snack packaging, the snack pieces and snack packaging together defining a saleable performance snack food item; and
offering the saleable performance snack food item for sale to consumers.

2. The method of claim 1, wherein placing the multitude of snack food pieces in a snack packaging includes placing the multitude of snack food pieces in a flexible snack packaging adapted to be placed in a standing, upright position when not in use.

3. The method of claim 1, further comprising a step, performed by a consumer, of consuming at least a portion of the multitude of snack food pieces while participating in computer or video game activity.

4. The method of claim 3, wherein the consuming step is carried out while manipulating a computer or video game control device.

5. The method of claim 4, wherein the consuming step is carried out by a person having two hands, and where such step includes holding the flexible snack packaging in one hand while manipulating the computer or video game control device with the other hand.

6. The method of claim 3, further comprising a step, performed by a consumer while participating in computer or video game activity, of opening the flexible snack packaging before the consuming step.

7. The method of claim 6, further comprising a step, performed by a consumer while participating in computer or video game activity, of closing the flexible snack packaging after completion of the consuming step and placing the packaging in a standing, upright position on a generally horizontal surface.

8. The method of claim 1, wherein the providing step includes promoting sale of the saleable performance snack food item to consumers for use during computer or video game activity.

9. The method of claim 8, wherein promoting sale of the saleable performance snack food item to consumers for use during computer or video game activity includes offering the saleable performance snack food item for sale in association with offering computer or video games for sale or rental.

10. The method of claim 3, wherein the snack food pieces are granular, and wherein the consuming step includes pouring the snack food pieces from the snack packaging.

11. A cognitive performance snack food, adapted to be consumed while engaging in computer or video game activity and to provide cognitive performance enhancement thereby, comprising:
a plurality of snack food pieces, each piece including:
a snack food base piece, each snack food base piece having a solid structure,
a mixture of cognitive performance additives applied to surfaces of the snack food base piece, and
an edible encapsulation layer surrounding the snack food base piece;
wherein the snack food pieces are adapted to be pourable from a dispensing container.

12. The method of claim 11, wherein the plurality of snack food pieces are a first plurality of snack food pieces, wherein the cognitive performance snack food further includes a second plurality of snack food pieces whose surfaces do not have the mixture of cognitive performance additives applied thereto, and wherein the first and second pluralities of snack food pieces are adapted to be pourable from the dispensing container.

13. A saleable performance snack food item, adapted to be consumed while engaging in computer or video game activity and to provide cognitive performance enhancement thereby, comprising:
a flexible snack packaging adapted to be opened and closed with one hand and to be placed in a standing, upright position when not in use; and
a cognitive performance snack food, contained in the snack packaging, arranged in snack food pieces, the snack food including:
a snack food base,
a mixture of cognitive performance additives, and
an edible outer shell.

14. The saleable performance snack food item of claim 13, wherein the snack food pieces are granular and adapted to be pourable from the snack packaging.

15. The saleable performance snack food item of claim 14, wherein the snack food base is prepared as a food mixture, and wherein the cognitive performance mixture is combined with the food mixture to obtain a homogeneous mixture of food material.

16. The saleable performance snack food item of claim 15, wherein each piece of the cognitive performance snack food is cooked from the homogeneous mixture.

17. The saleable performance snack food item of claim 16, wherein each piece of the cognitive performance snack food is shaped from the homogeneous mixture prior to being made solid or semi-solid by being cooked, dried, frozen, refrigerated or allowed, at room temperature, to harden.

18. The saleable performance snack food item of claim 14, wherein each piece of the cognitive performance snack food is a snack food base piece, with a solid structure, having surfaces to which the mixture of cognitive performance additives is applied.

19. The saleable performance snack food item of claim 18, wherein each snack food base piece is a naturally occurring food.

20. The saleable performance snack food item of claim 18, wherein each snack food base piece is a previously prepared snack food piece.

21. The saleable performance snack food of claim 13, wherein the cognitive performance additives are contained in the edible outer shell.
